(19) United States
(12) Patent Application Publication
(10) Pub. No.: US 2008/0084511 A1
(43) Pub. Date: Apr. 10, 2008

(54) System and Method for Displaying an Image

(75) Inventors: Frank J. Moizio, Dallas, TX (US); Lars A. Yoder, Plano, TX (US); Wolfram K. Gauglitz, Dallas, TX (US); Michael T. Davis, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/866,587

(22) Filed: Oct. 3, 2007

Related U.S. Application Data
(60) Provisional application No. 60/828,179, filed on Oct. 4, 2006.

(51) Int. Cl. H04N 5/64; G03B 21/28

(52) U.S. Cl. 348/789; 353/98; 348/E05.128; 348/E05.129; 348/E05.13

(57) ABSTRACT

According to one embodiment, an apparatus for displaying an image includes an interface, an image generator, an optical lens, and a speaker. The interface accommodates a media device to dock the media device, and receives a data signal from the media device. The data signal comprises a video signal and an audio signal associated with an image. The image generator generates light beams according to the video signal. The optical lens projects the light beams to yield the image. The speaker emit sounds according to the audio signal.

### CROSS REFERENCE TO RELATED APPLICATIONS

This application claims the benefit of priority under 35 U.S.C. §119(e) of U.S. Provisional Patent Application Ser. No. 60/828,179 entitled “Video Docking System,” which was filed on Oct. 4, 2006, and which is incorporated herein by reference.

### TECHNICAL FIELD OF THE INVENTION

This invention relates generally to the field of image display systems and more specifically to a system and method for displaying an image.

### BACKGROUND OF THE INVENTION

Media devices, such as video IPODs, are capable of displaying an image. Certain media devices, however, have a relative small display screen. Additionally, various media devices require headphones to output audio associated with the displayed image.

### SUMMARY OF THE INVENTION

In accordance with the present invention, disadvantages and problems associated with previous techniques for displaying an image may be reduced or eliminated.

According to one embodiment, an apparatus for displaying an image includes an interface, an image generator, an optical lens, and a speaker. The interface accommodates a media device to dock the media device, and receives a data signal from the media device. The data signal comprises a video signal and an audio signal associated with an image. The image generator generates light beams according to the video signal. The optical lens projects the light beams to yield the image. The speaker emit sounds according to the audio signal.

Certain embodiments of the invention may provide one or more technical advantages. A technical advantage of one embodiment may be that a media device can be docked onto a portable projector. As a result, the displayed image is not restricted by the size of the display screen of the media device. A technical advantage of a further embodiment may be that an image from a media device may be displayed using solid state illumination, which may yield improved image quality.

A technical advantage of a further embodiment may be that an image from a projector may be displayed on a shell monitor. Displaying the image on a monitor may reduce the amount of surface ambient light that must be displaced, which may improve the image. A technical advantage of a further embodiment may be that the shell monitor is independent of a power source. This may result in a smaller, lighter, and less expensive monitor. A technical advantage of a further embodiment may be that live television broadcasts may be projected by the portable projector.

Certain embodiments of the invention may include none, some, or all of the above technical advantages. One or more technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1A is a diagram of one embodiment of a system for displaying an image;

FIG. 1B is a diagram of one embodiment of a system for displaying an image;

FIG. 2 is a block diagram of exemplary image display components of one embodiment of a projector for displaying an image;

FIG. 3 is a block diagram of exemplary image display components of one embodiment of a system for displaying an image; and

FIG. 4 is a diagram of one embodiment of a system for displaying an image.

### DETAILED DESCRIPTION OF THE INVENTION

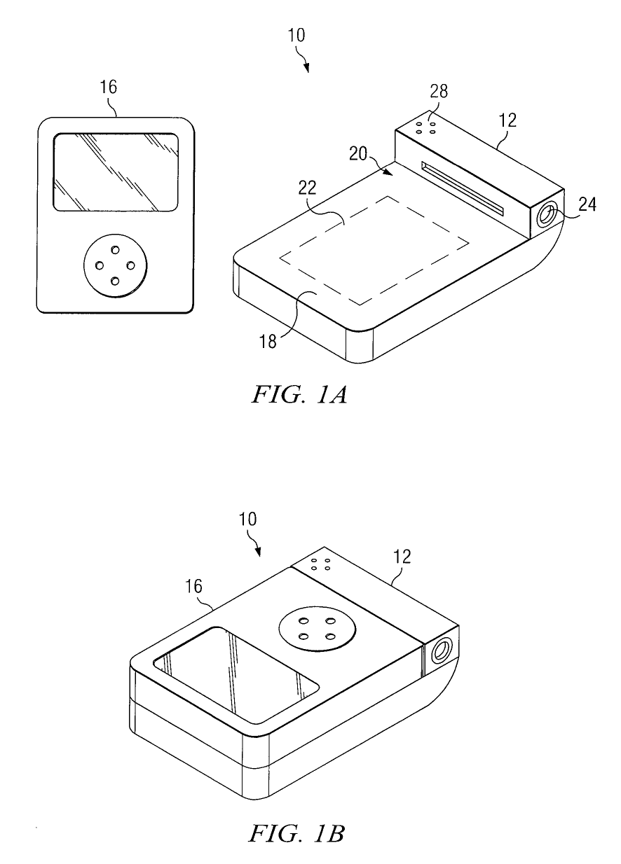

Embodiments of the present invention and its advantages are best understood by referring to FIGS. 1A through 4 of the drawings, like numerals being used for like and corresponding parts of the various drawings.

FIGS. 1A and 1B illustrate one embodiment of a system 10 for displaying an image. According to the illustrated embodiment, system 10 generally includes a projector 12 and a media device 16. Media device 16 may dock onto projector 12, as illustrated in FIG. 1B. Projector 12 may receive a video data signal from the docked media device 16, and project at least one image associated with the video data signal. Projector 12 may yield an image that is larger than an image generated solely by a media device.

In one embodiment, projector 12 may represent any device operable to receive a data signal, and further operable to project an image associated with the data signal onto an external object. Examples of projector 12 include a cathode ray tube (CRT) projector, a liquid crystal display (LCD) projector, a digital light processing (DLP) projector, and/or any other suitable projector. In one embodiment, projector 12 may represent a portable projector. A portable projector may weigh less than one pound, may be carried by a human hand, and may be stored in small spaces, such as a pocket. A portable projector may have an internal power supply, such as a battery. In another embodiment, projector 12 may represent a fixed projector. A fixed projector may be fixed to a floor, wall, or ceiling, and may further require a connection to an external power source, such as electrical outlet, in order to project an image.

As further illustrated in FIG. 1A, projector 12 generally includes a housing 18, an interface 20, an image generator 22, an optical lens 24, and a speaker 28. Interface 20 may be operable to couple media device 16 to projector 12. Housing 18 may house one or more components of projector 12, for example, interface 20, image generator 22, and/or speaker 28. Housing 18 may have any suitable dimensions that yield any suitable volume, such as less than 40 or less than 15 cubic centimeters.

Interface 20 may provide a docking station that allows at least a portion of media device 16 to dock onto projector 12, that is, to accommodate at least the portion without the use of cables. In the illustrated embodiment, interface 20 may allow the entire media device 16 to dock onto projector 12. By docking the entire media device 16 onto projector 12, system 10 may be more portable and more aesthetically pleasing. In one embodiment, interface 20 may be operable to allow projector 12 to receive data signals from media device 16. In the embodiment, a data signal includes a video data signal, an audio data signal, and/or any other suitable data signal provided by media device 16.

Image generator 22 may be operable to convert a digital signal to an image. The digital signal may include image data used to generate an image. Image generator 22 generates light beams according to the image data. When appropriately reflected from a surface, the light beams yield the image. Image generator 22 may include one or more light sources and one or more digital micro-mirror devices (DMDs) that are used to generate the light beams.

Optical lens 24 may be operable to project the light beams onto an external object to yield the image. Optical lens 24 may comprise any suitable material, for example, plastic, glass, and/or any other suitable material. Optical lens 24 may further be operable to adjust the projected image. For example, optical lens 24 may include a zoom lens operable to increase or decrease the image size without having to move projector 12. An “image” may refer to a single image frame (such as a slide) or to a sequence of image frames (such as a video).

Speaker 28 may be operable to emit sound associated with a data signal from projector 12. The data signal may include an audio data signal associated with an image projected by projector 12. Speaker 28 may represent a built-in speaker or an external speaker. Speaker 28 may allow a user to listen to sounds without the use of headphones.

Media device 16 may be operable to provide data signals to projector 12 through interface 16. Media device 16 may represent any device operable to store and send video and/or audio data signals to projector 12. For example, media device 16 may represent a video IPOD, a mobile phone, a digital camera, a portable gaming device, a media player, a portable media player, or any other suitable device. If the data signals include video and audio signals, the video and audio signals may be associated with each other to yield sounds coordinated with the image.

Modifications, additions, or omissions may be made to system 10 without departing from the scope of the invention. The components of system 10 may be integrated or separated according to particular needs. Moreover, the operations of system 10 may be performed by more, fewer, or other components.

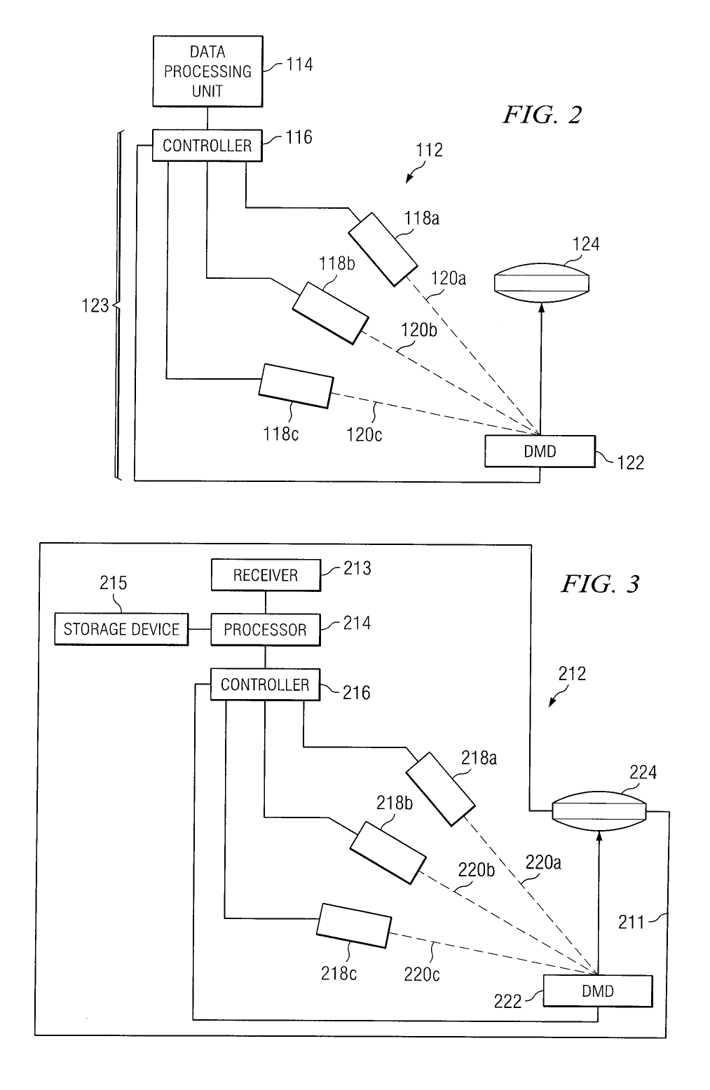

FIG. 2 is a block diagram of exemplary image display components of one embodiment of a projector 112 for displaying an image. Projector 112 is substantially similar to projector 12 of FIGS. 1A and 1B. According to the illustrated embodiment, projector 112 includes an image generator 123 and an optical lens 124. Image generator 123 includes a data processing unit 114, a controller 116, a plurality of light sources 118a-c, a digital micro-mirror device (DMD) 122, and an optical lens 124. As described in greater detail below, data processing unit 114 processes video data signals so that light sources 118a-c and DMD 122 may generate an image associated with the video data signals.

According to the illustrated embodiment, data processing unit 114 is operable to receive and process data signals. In one embodiment, data processing unit 114 receives data signals from a media device, such as media device 16 of FIGS. 1A and 1B. For example, data processing unit 114 may receive video data signals and audio data signals from a media device. In another embodiment, data processing unit 114 receives data signals from a user. For example, a user may select to increase or decrease the lumens provided by light sources 118a-c. Data processing unit 114 may be further operable to provide image data and control information to other components of projector 112, such as controller 116. Image data may refer to data that is used to generate an image. Control information may refer to instructions that are used to control components of projector 112 to process the image data.

Controller 116 may be operable to receive image data and control information from data processing unit 114, and further operable to control light sources 118a-c and DMD 122 in order to generate an image. For example, controller 116 may activate, deactivate, and control the intensity of each of the light sources 118a-c. As another example, controller 116 may control the “on” and “off” states of DMD 122.

Light sources 118 may include any suitable light source that provides a desired frequency or frequencies of light. For example, light sources 118 may include Light Emitting Diodes (LEDs), injection laser diodes (ILDs), vertical cavity surface emitting diodes (VCSELs), lasers, and/or any other suitable light source. The intensity of lights sources 118 may have any suitable value, for example, between 0 to 1000, 100 to 500, or 150 to 350 lumens, such as 250 lumens. In one embodiment, each light source 118 includes one or more LEDs operable to provide solid-state illumination. In another embodiment, a light source 118 may comprise multiple LEDs emitting either the same or different colors. In one embodiment, LEDs may be used to generate “field sequential” images of red, blue, and green components. In certain embodiments, light sources 118 may emit beams of narrow-band light of different colors.

In the illustrated embodiment, light sources 118 include light source 118a, light source 118b, and light source 118c which emit light beam 120a, light beam 120b, and light beam 120c, respectively. Light beams 120a, 120b, and 120c may have the same or different wavelength ranges. As another example, light beam 120a may have a wavelength on the order of 400-475 nanometers, that is, light source 118a may emit blue light. For example, light beam 120b may have a wavelength on the order of 485-570 nanometers, that is, light source 118b may emit green light. As yet another example, light beam 120c may have a wavelength on the order of 610-690 nanometers, that is, light source 118c may emit red light.

The number of light sources 118 and the wavelengths of light beams 120 are merely examples. Any number of light sources 118 may be selected to emit appropriate light beams 120 of any desired wavelength range suitable for projector 112. For example, light sources 118 may emit beams of primary colors, secondary colors, and/or white light.

Digital micro-mirror device (DMD) 122 may include a micro electro-mechanical device comprising an array of hundreds of thousands of individually tilting micro-mirrors. In a flat state, each micro-mirror may be substantially parallel to optical lens 124. From the flat state, the micro-mirrors may be tilted, for example, to a positive or negative angle to alternate the micro-mirrors between an “on” and an “off” state. To permit the micro-mirrors to tilt, each micro-mirror attaches to one or more hinges mounted on support posts, and spaced by means of an air gap over underlying control circuitry. The control circuitry provides electrostatic forces, based at least in part on image data received at DMD 122 from controller 116. The electrostatic forces cause each micro-mirror to selectively tilt. Light beams 120 received on the micro-mirror array may be reflected by the “on” micro-mirrors towards optical lens 124. Additionally, light beams 120 may be reflected by the “off” micro-mirrors towards a plurality of light dumps, not shown. The pattern of “on” versus “off” mirrors (e.g., light and dark mirrors) forms an image that is projected by optical lens 124. In various embodiments, DMD 122 is capable of generating various levels or shades for each color received.

Optical lens 124 is substantially similar to optical lens 24 of FIGS. 1A and 1B. For example, optical lens 24 may be operable to project an image onto an external object, such as a screen or a wall.

Modifications, additions, or omissions may be made to projector 112 without departing from the scope of the invention. The components of projector 112 may be integrated or separated according to particular needs. Moreover, the operations of projector 112 may be performed by more, fewer, or other components. For example, the operations of controller 116 may be performed by data processing unit 114.

FIG. 3 is a block diagram of exemplary image display components of one embodiment of a system 200 for displaying an image. According to the illustrated embodiment, system 200 generally includes a housing 211, a projector 212, a receiver 213, and a processor 214. In one embodiment, receiver 213 and processor 214 provide projector 212 with the ability to project live television images onto an external object, such as a wall or a screen.

Housing 211 may house one or more components of system 200, for example, projector 212, receiver 213, and/or processor 214. Housing 211 may have any suitable dimensions that yield any suitable volume, such as less than 45 or less than 15 cubic centimeters.

In one embodiment, projector 212 may represent any device operable to receive a data signal, and further operable to project an image associated with the data signal onto an external object. Examples of projector 212 include a cathode ray tube (CRT) projector, a liquid crystal display (LCD) projector, a digital light processing (DLP) projector, and/or any other suitable projector. In one embodiment, projector 212 may represent a portable projector. A portable projector may weigh less than one pound, may be carried by a human hand, and may be stored in small spaces, such as a pocket. A portable projector may have an internal power supply, such as a battery. In another embodiment, projector 212 may represent a fixed projector. A fixed projector may be fixed to a floor, wall, or ceiling, and may further require a connection to an external power source, such as electrical outlet, in order to project an image.

As illustrated in FIG. 3, projector 212 generally includes receiver 213, processor 214, a storage device 215, a controller 216, a plurality of light sources 218a-c, a digital micro-mirror device (DMD) 222, and an optical lens 224.

Receiver 213 may include a device operable to receive digital television signals and provide the signals to processor 214. For example, receiver 213 may be operable to receive Digital Video Broadcast-Handheld (DVB-H) Standard signals or Intersubband Transition (ISBT) Standard signals. In another embodiment, receiver 213 may be operable to receive signals associated with a mobile phone subscription plan.

Processor 214 may include any device operable to receive and process digital television signals. Processor 114 may be further operable to provide image data and control information to other components of projector 212, such as controller 216. Image data may refer to data that is used to generate an image. Control information may refer to instructions that are used to control components of projector 112 to process the image data. In another embodiment, processor 214 may transmit the digital television signals to storage device 215.

Storage device 215 may include any suitable device capable of storing data. For example, storage device 30 may include a magnetic disk, an optical disk, flash memory, or other suitable data storage device. In one embodiment, storage device 215 may be operable to store digital television signals. By storing the signals in storage device 215, processor 214 may retrieve the signals at anytime, such as after a live broadcast is complete. This may allow a user to store television broadcasts for viewing at a later time.

According to the illustrated embodiment, Controller 216 is substantially similar to controller 116 of FIG. 2; light sources 218a-c are substantially similar to lights sources 118a-c of FIG. 2; light beams 220a-c are substantially similar to lights beams 120a-c of FIG. 2; DMD 222 is substantially similar to DMD 122 of FIG. 2; and optical lens 224 is substantially similar to optical lens 124 of FIG. 2. Therefore, as illustrated in FIG. 3, receiver 213 and processor 214 respectively receive and process digital television signals so that light sources 118a-c and DMD 122 may generate an image associated with a live television broadcast.

Modifications, additions, or omissions may be made to system 200 without departing from the scope of the invention. The components of system 200 may be integrated or separated according to particular needs. Moreover, the operations of system 200 may be performed by more, fewer, or other components. For example, the operations of controller 216 may be performed by processor 214.

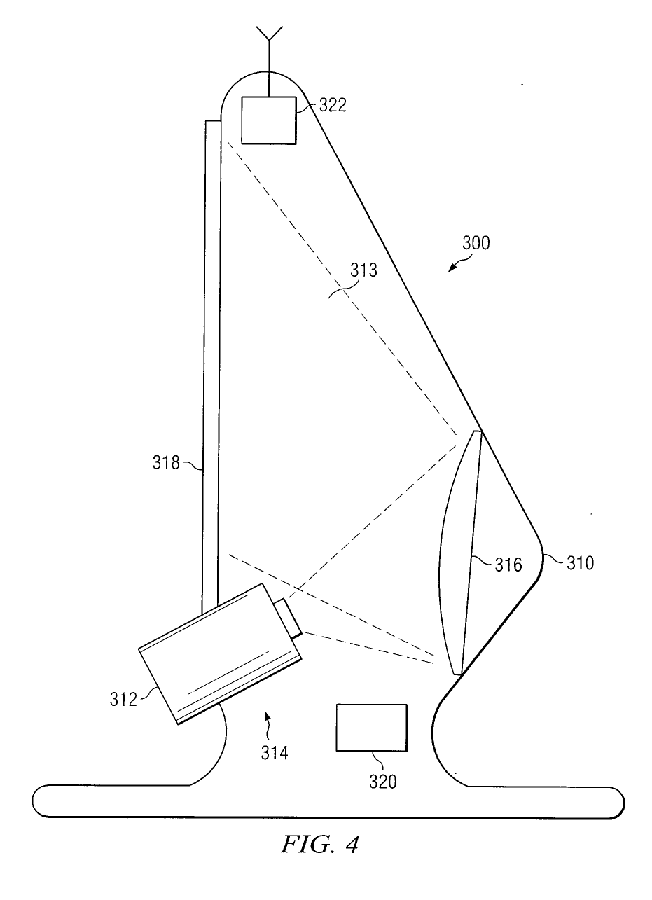

FIG. 4 is a diagram of one embodiment of a system 300 for displaying an image. According to the illustrated embodiment, system 300 generally includes a monitor 310 and a projector 312. In one embodiment, projector 312 may be coupled to monitor 310 in order to display a projected image on monitor 310. Displaying the projected image on monitor 310 may improve the image quality of projector 312. In a further embodiment, monitor 310 may display an image without requiring a power source.

Monitor 310 may include any device operable to display an image. According to the illustrated embodiment, monitor 310 generally includes a housing 313, an interface 314, a reflector 316, a screen 318, a power input 320, and a receiver 322. Housing 313 may house one or more components of monitor 310, for example, interface 314, reflector 316, and/or screen 318. Housing 313 may have any suitable dimensions that yield any suitable volume to support small and large viewing screen diagonals from a few inches to several feet.

Interface 310 may be operable to couple projector 312 to monitor 310. As illustrated, interface 314 may provide a docking area for projector 312. In one embodiment, interface 310 may be sized to allow projector 312 to be located substantially within monitor 310. In a further embodiment, interface 310 may allow projector 312 to project an image into monitor 310.

Reflector 316 may include a device operable to receive a projected image from projector 312, and further reflect the image onto screen 318. For example, reflector 316 may include one or more mirrors. According to the illustrated embodiment, monitor 310 only includes one reflector 316. In further embodiments, monitor 310 may include more than one reflector 316.

Screen 318 may include any device operable to receive an image on a first side, and further operable to display the image to a user on a second side. For example, screen 318 may include a standard television screen. According to one embodiment, projecting the image onto screen 318 may reduce the amount of surface ambient light that must be displaced by the image. As a result, the image displayed using screen 318 may be of improved quality.

Projector 312 is substantially similar to projector 12 of FIGS. 1A and 1B, projector 112 of FIG. 2, and projector 212 of FIG. 3. According to the illustrated embodiment, projector 312 is operable to project an image into monitor 310, and is further operable to project the image using its own power source. As a result, monitor 310 may be a display shell including only the interface 314, reflector 316, and screen 318. Consequently, monitor 310 may be independent of a power source. Furthermore, the lack of expensive and heavy electronic devices usually associated with conventional monitors may decrease the cost, size, and weight of monitor 310.

In one embodiment, receiver 322 may receive a data signal, such as a television signal, and supply the signal to projector 312. Input 320 may receive power from a power source and supply the power to projector 312.

In a further embodiment, monitor 310 may be an entertainment center. For example, monitor 310 may include a Digital Video Disc (DVD) player, a Video Cassette Recorder (VCR) player, a recording device, a gaming platform, or any suitable combination. In a further embodiment, monitor 310 may be a television set including a projector separate from projector 312.

Modifications, additions, or omissions may be made to system 200 without departing from the scope of the invention. The components of system 200 may be integrated or separated according to particular needs. Moreover, the operations of system 200 may be performed by more, fewer, or other components.

While this disclosure has been described in terms of certain embodiments and generally associated methods, alterations and permeations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. An apparatus for displaying an image, comprising:
an interface operable to:
accommodate a media device to dock the media device; and
receive a data signal from the media device, the data signal comprising:
a video signal associated with an image; and
an audio signal associated with the image;
an image generator operable to generate one or more light beams according to the video signal;
an optical lens operable to project the one or more light beams to yield the image; and
at least one speaker operable to emit sound according to the audio signal.

2. The apparatus of claim 1, the interface configured to accommodate the entire media device.

3. The apparatus of claim 1, the interface configured to accommodate a portion of the media device.

4. The apparatus of claim 1, wherein the image generator comprises one or more light emitting diodes operable to provide solid state illumination.

5. The apparatus of claim 1, wherein the image generator comprises a digital micro-mirror device (DMD).

6. The apparatus of claim 1, further comprising a housing, the image generator and the at least one speaker disposed within the housing, the housing occupying a volume of less than 45 cubic centimeters.

7. The apparatus of claim 1, further comprising a housing, the image generator and the at least one speaker disposed within the housing, the housing occupying a volume of less than 15 cubic centimeters.

8. The apparatus of claim 1, the interface configured to accommodate a media device comprising a member of the following group:
a video IPOD;
a mobile telephone;
a digital camera;
a portable gaming device;
a media player; or
a portable media player.

9. An apparatus for displaying an image, comprising:
a housing;
an interface coupled to the housing;
one or more reflective surfaces coupled to the housing;
a screen coupled to the housing, the screen comprising a first side and a second side;
the interface operable to receive a projector, the projector operable to project an image;
the one or more reflective surfaces operable to:
receive the image; and
reflect the image towards the screen;
the first side of the screen operable to receive the reflected image; and
the second side of the screen operable to display the image.

10. The apparatus of claim 9, the projector comprising one or more light emitting diodes operable to provide solid state illumination.

11. The apparatus of claim 9, the projector comprising a portable projector.

12. The apparatus of claim 9, operable to display the image independent of a power source.

13. The apparatus of claim 9, further comprising an input operable to:
receive power from a power source; and
supply the power to the projector.

14. The apparatus of claim 9, further comprising a receiver operable to:
receive a data signal; and
supply the data signal to the projector.

15. The apparatus of claim 9, the projector occupying a volume of less than 45 cubic centimeters.

16. The apparatus of claim 9, the projector occupying a volume of less than 15 cubic centimeters.

17. An apparatus for displaying an image, comprising:
a housing;
a receiver disposed within the housing;
a projector disposed within the housing; and
an optical lens coupled to the housing;
the receiver operable to receive one or more television signals communicating one or more images;
the projector operable to generate one or more light beams according to the one or more television signals; and
an optical lens operable to project the one or more light beams to yield the one or more images.

18. The system of claim 17, the housing occupying a volume of less than 45 cubic centimeters.

19. The system of claim 17, the housing occupying a volume of less than 15 cubic centimeters.

20. The system of claim 17, the projector comprising one or more light emitting diodes operable to provide solid state illumination.

21. The system of claim 17, the one or more television signals comprising one or more digital television signals.

22. An apparatus for displaying an image, comprising:
means for accommodating a media device to dock the media device;
means for receiving a data signal from the media device, the data signal comprising:
a video signal associated with an image; and
an audio signal associated with the image;
means for generating one or more light beams according to the video signal;
means for projecting the one or more light beams to yield the image; and
means for emitting sound according to the audio signal.
